(19) United States
(12) Patent Application Publication
(10) Pub. No.: US 2001/0005551 A1
(43) Pub. Date: Jun. 28, 2001

(54) STRIPLIKE MATERIAL FOR USE WITH SPRAYPAINTING

(76) Inventor: PAUL PETER SIERO, AMERSFOORT (NL)

Correspondence Address: THOMAS L LOCKHART, BRIDGEWATER PLACE, 333 BRIDGE STREET N W, P O BOX 352, GRAND RAPIDS, MI, 495010352

(21) Appl. No.: 09/246,028

(22) Filed: Feb. 5, 1999

(51) Int. Cl. B05D 1/02; B05D 1/36; B05D 1/32

(52) U.S. Cl. 428/343; 427/421; 427/402; 427/8; 428/195

(57) ABSTRACT

An adhesive tape for covering selected adjacent areas to be spraypainted has an adhesive on one side and a pattern of shapes in contrasting colors, for assessment of the saturation of paint, on the other side of the tape.

The invention relates to striplike material for use with spray painting. The invention more specifically relates to striplike material for assessment of at least the covering power or saturation of paint sprayed on a surface.

In spray painting a surface normally paint is sprayed on a card provided with a number of contrasting patterns. The saturation or covering is then assessed by looking at the covered part of said card. If the patterns are still at least partly visible through the paint, the saturation or covering is insufficient. If on the other hand the patterns are no longer visible even in pat, the saturation or covering will be assessed as sufficient and then the surface can be spraypainted.

Use of these known cards has the advantage that said covering power or saturation of the paint used can easily be assessed, but has the disadvantage that these cards have to be sprayed hard held, apart from the object, that is of the surface to be spraypainted.

A major object of the present invention is to provide a striplike material of the above mentioned sort in which said disadvantages are prevented, maintaining the advantages thereof.

A further object of the present invention is to provide such striplike material which can be spraypainted together with the surface to be spraypainted, for assessment of the covering power and/or saturation of said paint.

A still further object of the present invention is to provide a method for spraypainting a surface, simultaneously assessing the covering and/or saturation of the paint used.

These and further objects are reached with a striplike material characterized by the features of claim 1 or with a method characterized by the features of claim 10 respectively.

Using striplike material having an adhesive backing provides the possibility of easy attachment of said striplike material to said surface to be painted. Preferably bordering part of said surface to be spraypainted. The contrasting patterns then enable easy assessment of the covering and/or saturation of the paint sprayed on said surface since the same paint is sprayed on said material. Thus bordering of part of the surface to be painted is achieved in an appropriate manner, simultaneously providing means for said assessment. Said striplike material will stay in position by itself during painting.

The contrasting patterns are, according to the present invention, preferably chequered patterns, made of substantially rectangular shapes. It has surprisingly been recognized that straight dividing lines between the patterns further enhance the possibility of said assessment of covering and/or saturation of said paint.

Said patterns consist preferably of shapes in alternating light and dark, most preferably dark grey or black and white or creme colours. Since these are extreme contrasting shades, said assessment can be made even more easily and accurately.

A method according to the present invention is preferably further characterized by the features of claim 11. By using said adhesive tape for attaching covering material such as paper or foil to parts of the object not to be spraypainted, simultaneously the advantages are reached of very accurate bordering of part of the surface to be spraypainted, protection of the rest of said surface, at least of neighbouring parts thereof not be spraypainted and providing means for easy assessment of the covering power and/or saturation of the paint used.

In further elucidation of the present invention, by way of example a preferred embodiment of a product and method according to the present invention are described with reference to the drawings.

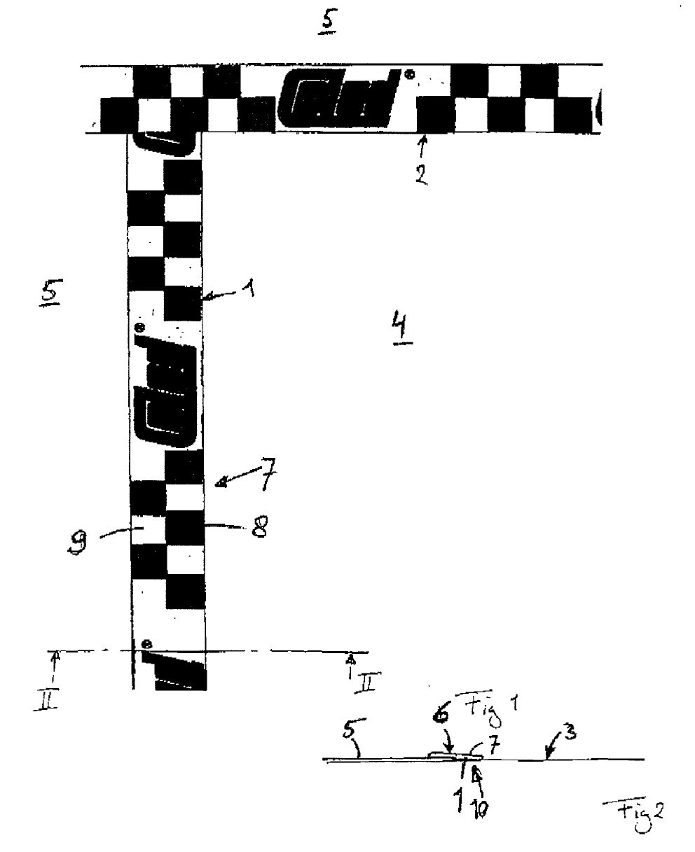

FIG. 1 shows a plan view of a surface to be spraypainted, bordered by striplike material according to the present invention; and

FIG. 2 shows an assembly according to the invention, in cross section along the line II-II in FIG. 1.

A first strip 1 and a second strip 2 of striplike material according to the present invention are adhered to a surface 3, perpendicular to each other, such as to border a part 4 of said surface 3. In FIG. 1 only one corner of for example a rectangular part 4 is shown. The part of the surface 3 under strips 1 and 2 and on the opposite side of part 4 thereof should not be spraypainted. To this aim a shielding material 5 is positioned on top of said parts of said surface 3, which shielding material 5 as held in position by the strips 1 and 2. Said shielding material can be for example paper or foil having a relatively small thickness but good shielding properties. The surface 3 is for example a body part of a vehicle.

Each strip 1, 2 consists of an elongated strip of paper or plastic material or the like such as crepe tape, at the top side 6 being provided with a pattern 7, generally existing of first shapes 8 and second shapes 9, said shapes 8, 9 being of contrasting colours. In the embodiment shown, the shapes 8, 9 are rectangular, more specifically square, the first shapes 8 being black, the second shapes 9 being white. As can be seen from FIG. 1 said chequered patterns 7 may be provided on only part of the strips 1, 2 of material, said top side 6 further being provided with for example branding or the like. In the embodiment shown two rows of alternating first 8 and second shapes 9 are provided width wise. However, it will be obvious that a different number of rows of alternating shapes could be provided on similar strips of material, depending on for example the overall width of said strips 1, 2.

On the bottom side 10 said striplike material 1, 2 has been provided with an adhesive, more specifically a releasable adhesive, comparable to for example adhesive normally used for covering tape used with painting. This has the advantage that the strips 1, 2 can easily be adhered to said surfaces 3 and/or to said shielding material 5 to said surface 3, as shown in FIG. 2 and can also easily be taken away again, after spraypainting the surface 3, at least said part 4 thereof and the striplike material 1, 2.

When the strips 1, 2 and the shielding material 5 have been accurately arranged on said surface 3 these can be spraypainted in a normal, commonly known way. The paint will be sprayed on said part 4 of said surface 3 and on the top surface 6 of the strips 1, 2, covering at least part of the chequered pattern 7. Due to the contrasting colours of said shapes 8, 9 the covering power of the paint sprayed and/or the saturating thereof can be easily assessed by monitoring said strips 1, 2. Indeed, if especially the dividing lines between the contrasting shapes 8, 9 can be recognised through said paint in will be clear that the covering power of said paint and/or the saturation thereof is insufficient, whereas if said tape has been fully covered, shielding said dividing lines from view, said covering power and/or said saturating is sufficient. This has the advantage that said covering power and/or saturating can very easily be assessed during spraypainting, the shielding material being held in position at the same time.

It will be clear to a person skilled in the art that the strips 1, 2 can, and indeed do form shielding material themselves. Therefore, said strips 1, 2 could be made of sufficient width to eliminate the necessity of using further shielding material.

The present invention is by no means limited to the embodiment as described with reference to the drawings. Many amendments can be made within the scope of the present invention as described in the claims. For example, different patterns and/or different shapes could be used, for example polygonal or irregular shapes, whereas the shapes could have different colours, for example dark grey and creme colour. The shapes could also have colours contrasting to the colour of the paint to be sprayed. Such embodiments should be considered as falling within the scope of the present invention.

1. Striplike material for use in spray painting surfaces, said material being provided with adhesive at a first side and a pattern at the opposite side, comprising shapes in contrasting colours, suitable for assessment of at least the saturation of or covering by paint sprayed there on and on said surfaces.

2. Striplike material according to claim 1, wherein said pattern is a chequered pattern.

3. Striplike material according to claim 2, wherein said chequered pattern comprises substantially rectangular shapes.

4. Striplike material according to claim 3, wherein said pattern is made up of square shapes.

5. Striplike material according to claim 1, wherein said shapes use of substantially identical size, preferably of substantially identical size and shape.

6. Striplike material according to claim 1, made of paperlike material.

7. Striplike material according to claim 1, wherein at least a first set of said shapes is dark, preferably grey or black, and a second set of said shapes is light, preferably white or creme coloured.

8. Striplike material according to claim 1, wherein said adhesive is a releasable adhesive.

9. Use of adhesive tape having a pattern of contrasting shapes in spray painting surfaces, wherein paint is sprayed on said surface and on at least part of said pattern, after which at least the saturation or covering power of the paint on said surfaces is assessed by comparison to the saturation or covering power of said paint on said pattern.

10. Method for spray painting part of a surface of a product, wherein at least one strip of adhesive tape having a pattern of contrasting shapes is stuck on said surface, preferably boarding the part of the surface to be spraypainted, after which said part of said surface is spraypainted, such that at least part of said pattern is covered with paint in a manner comparable to and preferably identical to said part of said surface, at least the saturation or covering power of paint on said part of said surface being assessed by comparison to the saturation or covering power of paint on said pattern.

11. Method according to claim 10, wherein shielding material such as paper or foil is releasably attached to said surface using said adhesive tape, for covering parts of said surface not to be spraypainted.
